(19) United States
(12) Patent Application Publication
(10) Pub. No.: US 2007/0146546 A1
(43) Pub. Date: Jun. 28, 2007

(54) Display control device and display control method

(76) Inventors: Tomoaki Kozaki, Kyoto (JP); Kensuke Odani, Kyoto (JP); Kengo Nishimura, Osaka (JP); Kunihiko Hayashi, Osaka (JP)

Correspondence Address: MCDERMOTT WILL & EMERY LLP, 600 13TH STREET, N.W., WASHINGTON, DC, 20005-3096, US

(21) Appl. No.: 11/636,501

(22) Filed: Dec. 11, 2006

(30) Foreign Application Priority Data
Dec. 14, 2005 (JP) 2005-361058

(51) Int. Cl. H04N 5/445

(52) U.S. Cl. 348/564; 348/706; 348/565

(57) ABSTRACT

A display control selection section receives a plurality of display control requirements for screen display and selects and outputs to an input timing control section a display control requirement capable of being processed within a single screen non-display interval out of the received display control requirements. The input timing control section outputs the display control requirement selected by the display control selection section to a display processor when the screen non-display interval comes.

### CROSS REFERENCE TO RELATED APPLICATIONS

This Non-provisional application claims priority under 35 U.S.C. § 119(a) on Patent Application No. 2005-361058 filed in Japan on Dec. 14, 2005, the entire contents of which are hereby incorporated by reference.

### BACKGROUND OF THE INVENTION

1. Field of the Invention

The present invention relates to a display control device and a display control method for controlling screen display.

2. Background Art

A display control device for controlling screen display is incorporated in, for example, a TV to perform processing relating to display in response to user's requirement. The processing relating to display (display control) includes exchange between display and non-display of a screen, display range setting of display data (display address setting), display size setting in the case where only a part of an actual screen is used for display, display data rewriting, and the like.

Generally, a display device that performs display using raster scan, in order not to cause display noise, display control is performed in a vertical blanking interval, that is, non-display interval. In other words, display control must be performed in response to a display control requirement only when the vertical blanking interval comes.

In the case where display is performed while a storage region for display data, such as a motion video is rewritten, however, if the amount of data to be rewritten is large, the rewriting cannot be completed within the vertical blanking interval, causing display noise in the screen.

To tackling this problem, a display control device has been proposed which is provided with a region (a frame buffer) for display data rewriting and a region (a frame buffer) for output and screen display separately (see Japanese Patent Application Laid Open Publication No. 8-146941A, for example). This display control device enables rewriting of a storage region (a frame buffer) in a vertical blanking interval, so that, for example, the screen can be scrolled without causing display noise.

Display control devices, however, must perform various kinds of display controls, such as exchange between display and non-display of the screen, display address setting, and the like, besides the storage region rewriting. If display control requirements increases too much in association with an increase in performance of appliances to be processed within a vertical blanking interval, display noise may be caused.

### SUMMARY OF THE INVENTION

The present invention has been made in view of the foregoing and has its object of providing a display control device for controlling screen display which can suppress display noise even if display control requirements mass in a given period.

To attain the above object, one aspect of the present invention provides a display control device for controlling screen display of a display device that performs display using raster scan, including:

a display control selection section, which receives a plurality of display control requirements for screen display, for selecting a display control requirement capable of being processed in a single screen non-display interval out of the received display control requirements; and

an input timing control section for providing, when the screen non-display interval comes, the display control requirement selected by the display control selection section to a display processor which performs display control according to the selected display control requirement.

### BRIEF DESCRIPTION OF THE DRAWINGS

FIG. 1 is a block diagram showing a configuration of a display control device according to an embodiment of the present invention.

FIG. 2 is an illustration showing one example of screens superimposed and displayed.

FIG. 3 is a flowchart depicting an operation of a display control selection section 141.

FIG. 4 is a chart showing timings at which an input timing control section 142 inputs display control requirements.

FIG. 5 is an illustration showing screen states before and after display control.

FIG. 6 is chart showing timings at which the input timing control section 142 inputs display control requirements under the display control in FIG. 5.

FIG. 7 is an illustration showing an example of screen states under display control where motion videos have a higher priority than still images.

FIG. 8 is a list explaining precedence of display control requirements under the display control in FIG. 7.

### DETAILED DESCRIPTION OF THE PREFERRED EMBODIMENT

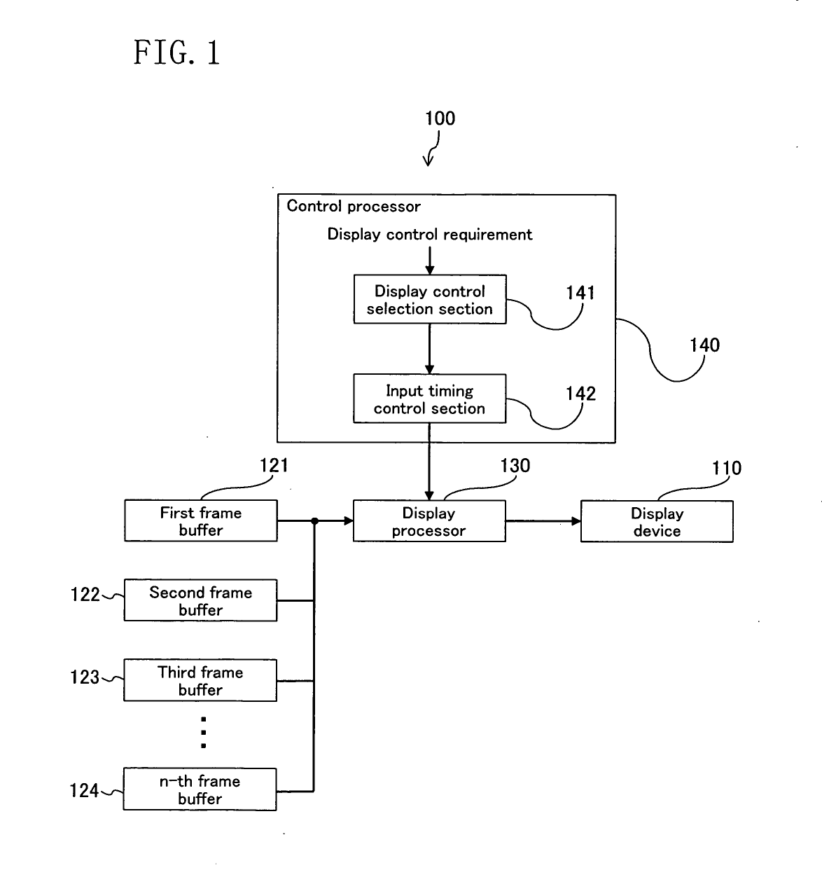

FIG. 1 is a block diagram showing a configuration of a display control device 100 according an embodiment of the present invention. The display control device 100 is incorporated in, for example, a TV for superimposing and displaying a plurality of screens, such as a main screen, a child screen, a menu, and the like.

The display control device 100 includes, as shown in FIG. 1, a plurality of frame buffers (a first frame buffer 121, a second frame buffer 122, a third frame buffer 123, . . . , and an n-th frame buffer 124), a display processor 130, and a control processor 140 and is connected to a display device 110.

The display device 110 displays input image information (image information of a motion video and a still image) on a screen including the main screen ranging over the entire screen, the childe screen ranging smaller than the main screen at a predetermined part of the screen, and the menu indicating various kinds of settings and the like to be executed.

The first to n-th frame buffers 121 to 124 serve as storage regions for storing to-be-displayed image information. In the present embodiment, for example, the first frame buffer 121 stores image information to be displayed on the main screen, the second frame buffer 122 stores image information to be displayed on the child screen, and the third frame buffer 123 stores image information displayed as the menu.

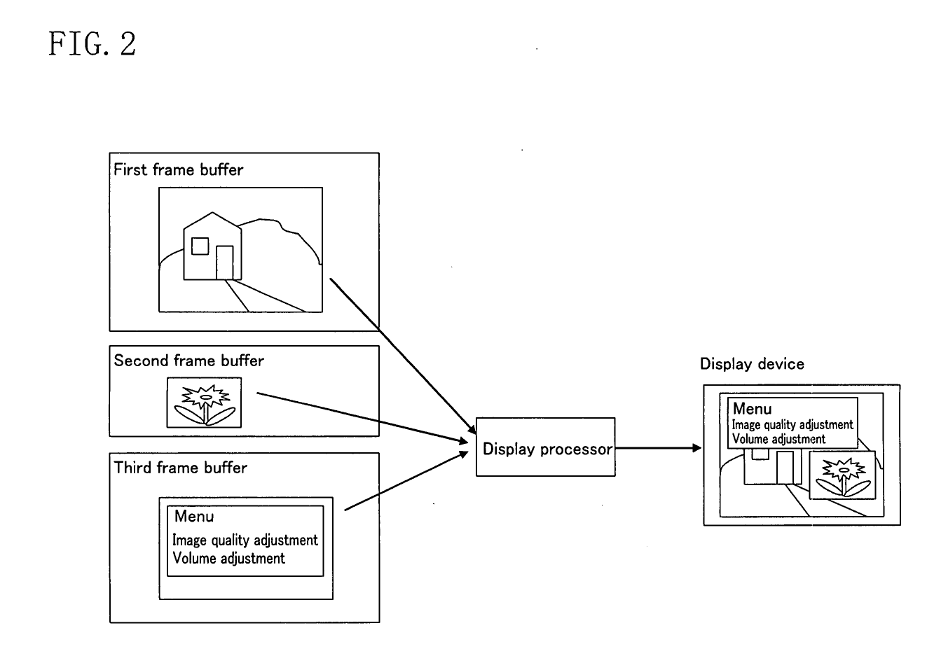

The display processor 130 outputs to the display device 110 the image information stored in any of the first frame buffer 121 to n-th frame buffers 124 in response to a requirement from the control processor 140. The display processor 130 allows the main screen, the child screen, and the menu to be superimposed and displayed on the screen of the display device 110 (see FIG. 2).

The control processor 140 includes a display control selection section 141 and an input timing control section 142 The display control selection section 141 receives a plurality of display control requirements (for example, exchanges between display and non-display of the menu or the child screen, and the like) and judges a display control requirement capable of being processed within a single vertical blanking interval so that the selected display control requirement is input to the display processor 130 via the input timing control section 142.

The aforementioned display control requirements are user's instruction to the display device 110 which is fragmented into actual operations. For example, when the user specifies a menu by pushing a menu display button of a remote control unit, three kinds of display control requirements of “menu display position setting,” “menu display size setting,” and “menu exchange from OFF to ON” are input to the display control selection section 141. Wherein, in the present embodiment, an external control CPU (not shown) or the like performs the above fragmentation and outputs the result to the display control selection section 141.

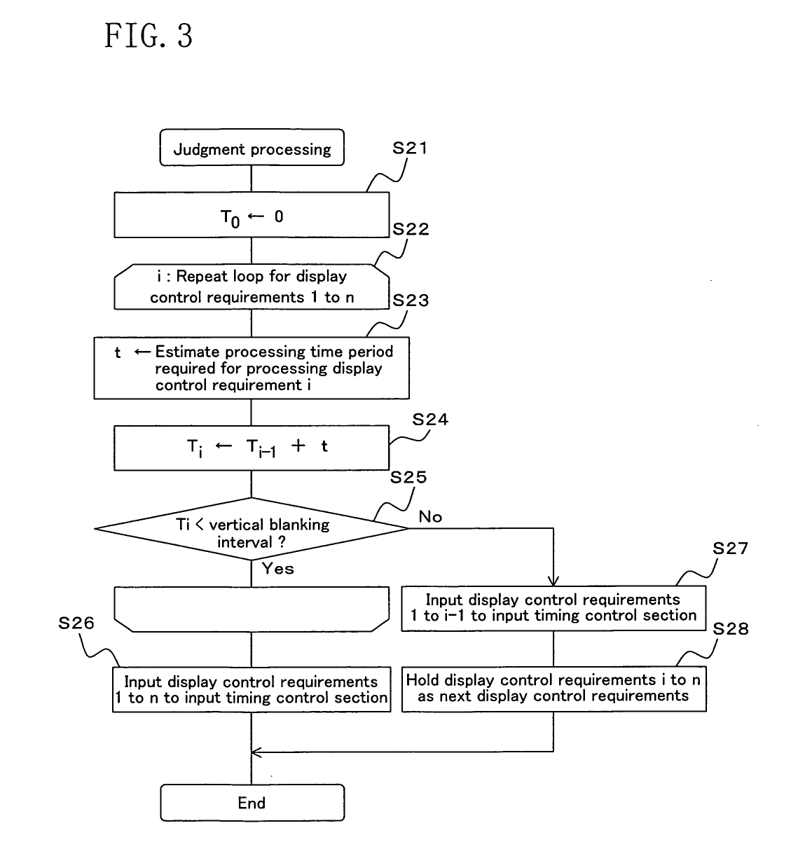

Specifically, the display control selection section 141 performs judgment along the flowchart shown in FIG. 3. The display control requirements that the display control selection section 141 receives are numbered from 1 to n in sequence of receipt, wherein n is the number of received display requirements.

First, in a step S21, a total display control processing time period T is initialized. Herein, Ti (i=an integer not larger than n, and T0 indicates the initial state) is an estimated total processing time period that the display processor 130 requires for processing first to i-th display control requirements.

Next, in a step S22, a loop of steps S23 to S25 is performed n times. The loop is interrupted according to judgment result in the step S25, which will be described later.

In the step S23, upon receipt of a display control requirement, an estimate display control processing time period t that the display processor 130 requires for processing the display control requirement is obtained. Next, in the step S24, the estimate display control processing time period t1 of the first display control requirement is set as a total estimate display control time period Ti. As to the second and following display control requirements, the obtained estimate display control processing time period ti at that time is added to the total display control processing time period T(i−1) to obtain the total display control processing time period Ti required for processing the display control requirements up to this time.

In the step S25, the total display control processing time period Ti is compared with a vertical blanking interval. When the estimate total display control processing time period Ti is shorter than the vertical blanking time, the routine returns to the step S22 to repeat the loop. When the estimate total display control processing time period Ti is equal to or larger than the vertical blanking time, which means that a remaining received display control requirement cannot be processed in the vertical blanking interval, the repetition of the loop is interrupted and the routine proceeds to a step S27.

In the step S27, the display control requirements before the loop interruption, namely, the first to (i−1)-th display control requirements are input to the input timing control section 142. The i-th to n-th display control requirements are transferred to the next judgment in the display control selection section 141.

On the other hand, when it is judged that all of the received display control requirements can be processed within the vertical blanking interval, the routine proceeds to a step S26 and all of the first to n-th display control requirements are input to the input timing control section 142.

In the case where display noise is caused in the screen, specifically, in the case where an image different from a final target image, that is, an unexpected image is displayed unless some of the display control requirements are processed in combination within a single vertical blanking interval, the display control selection section 141 in the present embodiment estimates a processing time period of the combination as an undividable processing group of requirements.

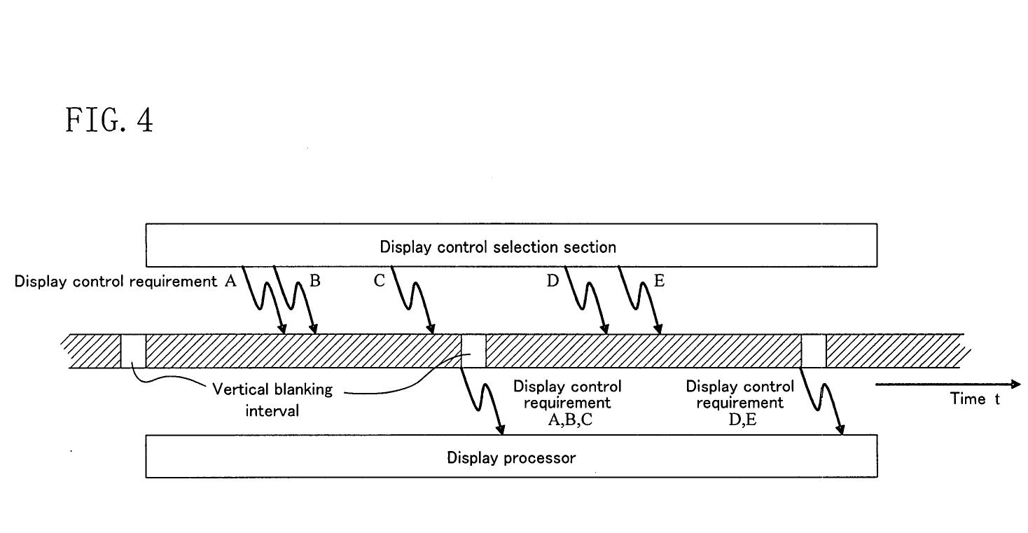

The input timing control section 142 receives the selected display control requirement(s) from the display control selection section 141 and inputs it/them to the display processor 130 only after the vertical blanking interval comes. FIG. 4 schematically shows an operation of the input timing control section 142.

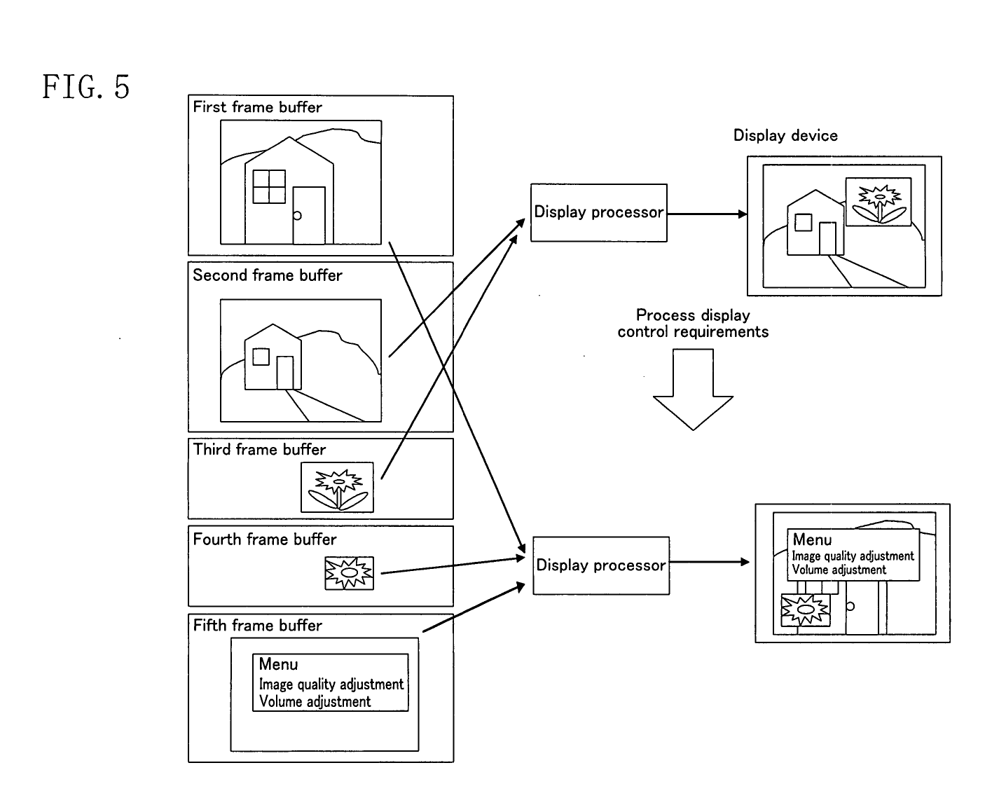

Description will be given to each processing of the above described constitutional elements with respect to the display control requirements for the respective screens. The concrete example herein presents the case where in the state shown in the upper right screen example in FIG. 5 in which an image of the child screen is superimposed on an image of the main screen, there are executed at once image exchange in the main screen, image exchange in the child screen with the display position changed, and display of the mane, as shown in the lower right screen example in FIG. 5.

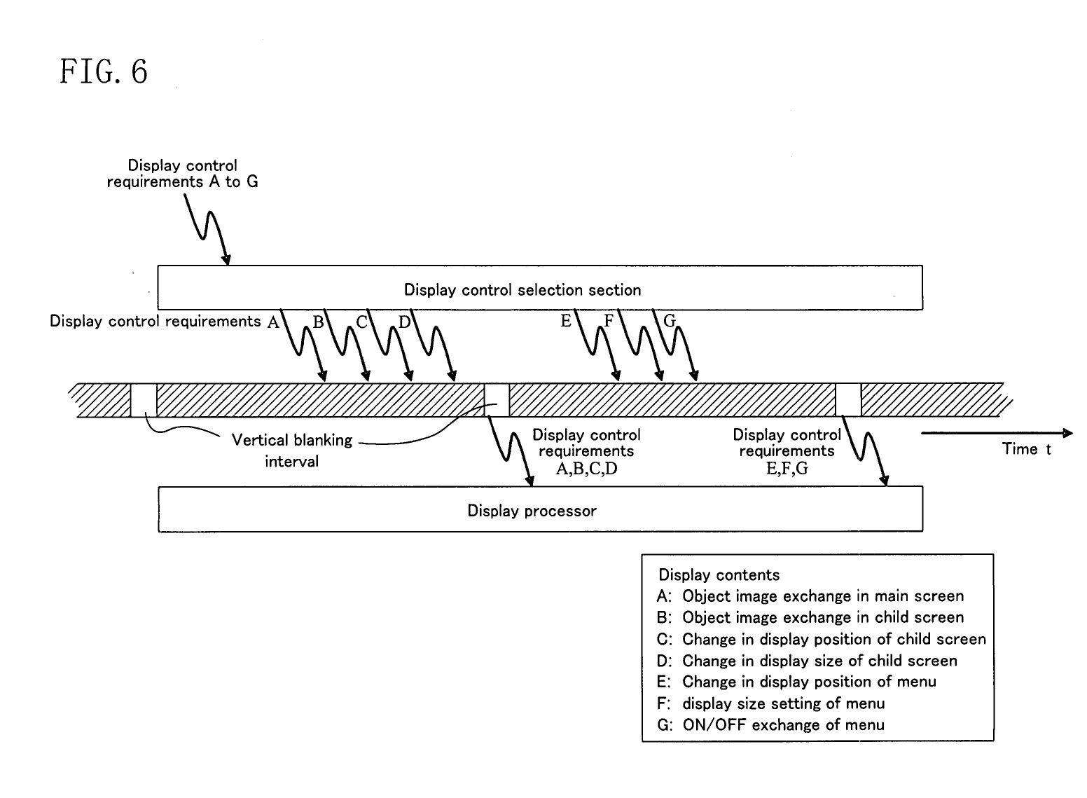

In this case, seven display control requirements A to G listed in the lower right part in FIG. 6 are necessary, wherein the display control selection section 141 receives them in this order. Herein, actual processing time periods of the display control requirements A to G which the display processor 130 requires are supposed to be equal to each other for the sake of simple explanation. Also suppose that five display control requirements out of the seven A to G can be processed within a single vertical blanking interval and six requirements cannot be processed therewithin.

Further suppose that: if image exchange in the child screen with no display position and display size unchanged or change in display position or display size with no image exchanged therein causes image nose in the screen, for example, an image of an unexpected region in a buffer frame is displayed for an extremely brief moment (a period when one frame or one field is displayed); and that the same is applied to the display control requirements E, F, G for menu display. Therefore, in the present concrete example, the display control requirements for the child screen must be processed in combination within a single vertical blanking interval, and the display control requirements for the menu must be processed in combination within a single vertical blanking interval. Accordingly, the display control selection section 141 judges the display control requirements in the example of FIG. 6 as three display control requirement groups A, (B to D), and (E to G).

When the display control requirements A to G are applied to the flowchart of FIG. 3, it is judged that either processing of only the display control requirement A and the display control requirements A plus (B to D) can be completed within a single vertical blanking interval. In contrast, it is judged that all of the requirements A plus (B to D) plus (E to G) cannot be processed within a single vertical interval. As a result of the judgment, the display control selection section 141 inputs to the input timing control section 142 the display control requirements A to D so that only the display control requirements A and (B to D) are processed in a vertical blanking interval immediately after the display control requirement selection and the remaining requirements (E to G) are processed in the next vertical blanking interval.

Though this causes menu display with one-frame or one-field delay behind image exchange of the main screen and image exchange of the child screen, no display noise in the screen is caused, inviting no uncomfortable feeling in human's sense of sight.

As descried above, according to the present embodiment, even when display control requirements to be processed within a screen non-display interval mass at a given period, all the display control requirements are processed only in the screen non-display interval(s), suppressing display noise.

(Modified Example of Display Control Selection Section 141)

In the display control selection section 141, precedent may be determined in advance according to, for example, contents of the display control requirements so as to estimate the processing times in sequence of the precedent.

The precedence may be determined so as not to cause display noise in the screen under display control, for example.

The present modified example refers to an example in which the precedence is determined so that display control on motion videos is prioritized to display control on still images and that display control on image data such as a picture is prioritized to display control on character information such as menu display in the still images.

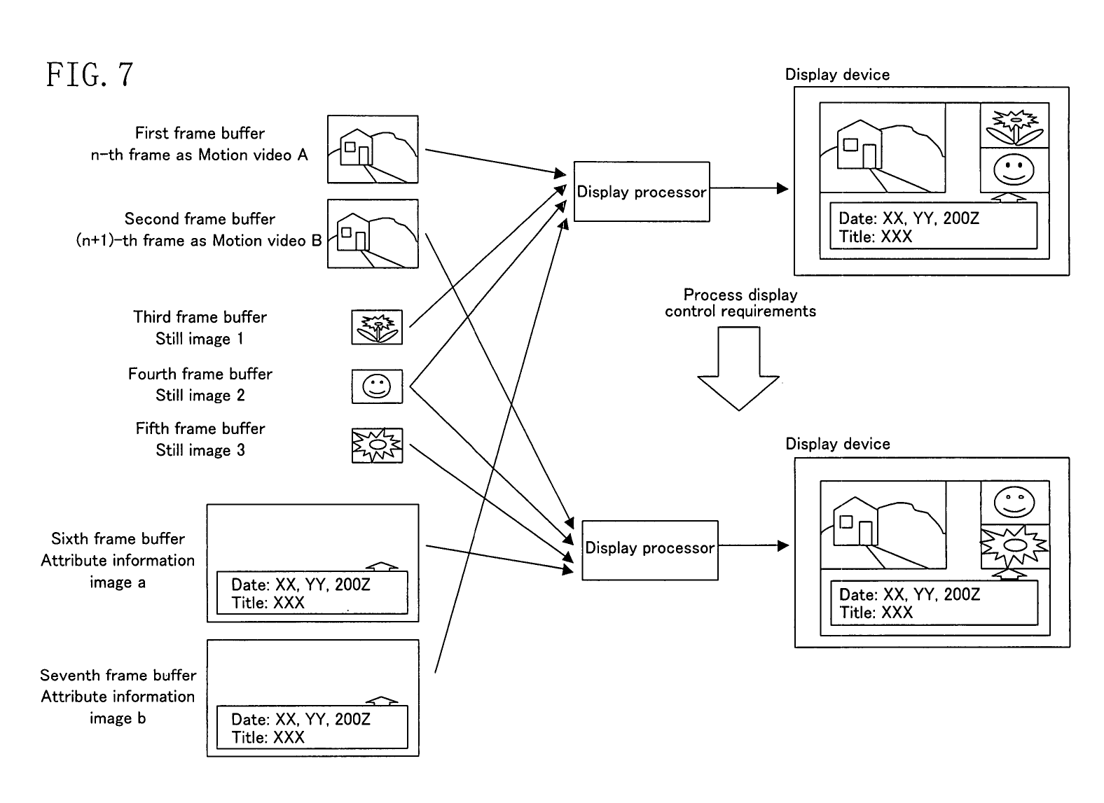

FIG. 7 is an illustration showing an example of a screen state under display control with the above precedence. In this example, the initial screen displays an n-th frame of a motion video A at the upper left part of the screen, two upper and lower still images (a still image 1 and a still image 2) are displayed in a still image display region at the upper right part of the screen, and attribute information on the still image 2 (attribute information image a) is displayed as a menu at the lower part of the screen. From this state, the frame of the motion video A is updated to the (n+1)-th frame as a motion video B, the lower still image 2 is moved upward, another still image (a still image 3) is displayed at the part where the still image 2 has been displayed, and attribute information of the newly displayed still image 3 (attribute information image b) is displayed as a menu at the lower part of the screen.

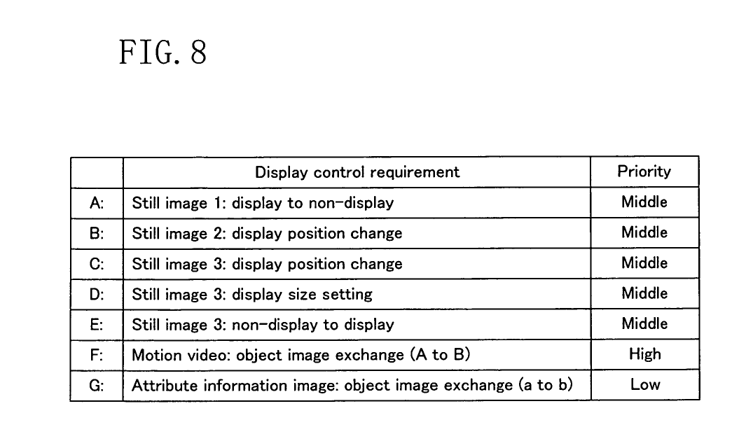

In order to change the screen display in this way, seven display controls A to G, for example, shown in FIG. 8 are necessary. Wherein, actual time periods that the display processor 130 requires for processing the display control requirements A to G are equal to each other herein for the sake of simple explanation. As well, five display control requirements out of the seven A to G can be processed within a single vertical blanking interval, but sixth and seventh display controls overflow from the vertical blanking interval.

In the present modified example, three kinds of priorities of “high,” “middle,” and “low” are given to display control requirements for motion vides, display control requirements for image data, such as pictures, and display control requirements for character information, such as menus, attribute information on pictures, and the like, respectively. Display control requirements having the same priority are processed in sequence of receipt.

With the precedence set as above, the display control requirements F, A, B, C, and D are processed in this order within a single vertical blanking interval first, and the display control requirements E and G are processed in the next vertical blanking interval. Accordingly, the newly displayed still image 3 and the attribute information thereof (attribute information image b) are displayed with one-frame delay behind the other images.

As described above, in the present modified example, motion videos are subjected to display control prior to still images, inviting no drop frame which is caused due to deferred processing for video images. Hence, display control is performed without causing uncomfortable filling in human sense of sight. The precedence may not be fixed permanently, namely, may change according to a situation. For example, the precedence may be changed dynamically judging from the contents of the currently displayed screen, the priority of a display control requirement transferred to the next blanking interval may increase, or the like.

The above embodiment including the modified example is applicable to, besides the TV exemplified as an applicable example of the display control device, any appliances that performs display using raster scan. For example, it is applicable to a display section of a video camera and the like.

The control processor 140 and the display processor 130 may be combined into a single processor. Such the combined processor may have to process a requirement other than the display control requirement within a vertical blanking interval. For providing countermeasures thereagainst, a time period usable for display control in a vertical blanking interval is estimated in advance, and the estimate display control processing time period Ti required for display control processing is compared with the time period usable for the display control rather than the vertical blanking interval in the step S25.

In the case where only the site where the display control requirements are issued (for example, an external CPU) can perform the judgment, information indicating undividable combination of display control requirements may be provided from the site where the display control requirements are issued to the display control selection section 141 together with the display control requirements.

As described above, even if a large number of display control requirements mass in a given period, the display control device and the display control method according to the present invention process all the display control requirements only in the screen non-display interval(s), thereby exhibiting effects of suppressing display noise in the screen. Hence, the present invention is useful as a display control device and the like for controlling screen display.

What is claimed is:

1. A display control device for controlling screen display of a display device that performs display using raster scan, comprising:
a display control selection section, which receives a plurality of display control requirements for screen display, for selecting a display control requirement capable of being processed in a single screen non-display interval out of the received display control requirements; and
an input timing control section for providing, when the screen non-display interval comes, the display control requirement selected by the display control selection section to a display processor which performs display control according to the selected display control requirement.

2. The display control device of claim 1,
wherein the display control selection section estimates and adds respective processing time periods required for processing the respective display control requirements in sequence of receipt of the display control requirements and selects one or more display control requirements of which total estimate processing time period falls within the single screen non-display interval out of the received display control requirements.

3. The display control device of claim 1,
wherein the display control selection section estimates and adds respective processing time periods required for processing the respective display control requirements in sequence of precedence, which is determined in advance according to control contents, and selects one or more display control requirements of which total estimate processing time period falls within the single screen non-display interval out of the received display control requirements.

4. The display control device of claim 3,
wherein the display control selection section changes the precedence so as to set a priority of an unselected display control requirement out of the received display control requirements to be higher than a currently set priority thereof, and includes the display control requirement of which priority is thus set as a selection candidate in a next screen non-display interval.

5. The display control device of claim 3,
wherein the precedence is determined so as to prevent display noise in a screen.

6. The display control device of claim 5,
wherein the precedence is determined so that a display control requirement for a motion video has a priority higher than a display control requirement for a still image.

7. The display control device of claim 1,
wherein the display control selection section selects display control requirements so that the display control requirements are processed in a single screen non-display interval, the display control requirements causing an image different from a final target image to be displayed unless each of the display control requirements are processed in a single screen non-display interval.

8. A display control method for controlling screen display of a display device that performs display using raster scan, comprising:
a display control selection step of receiving a plurality of display control requirements for screen display and selecting a display control requirement capable of being processed in a single screen non-display interval out of the received display control requirements; and
input timing control step of providing, when a screen non-display interval comes, the display control requirement selected in the display control selection step to a display processor that performs display control according to the selected display control requirement.
